(19) United States
(12) Patent Application Publication
(10) Pub. No.: US 2009/0308691 A1
(43) Pub. Date: Dec. 17, 2009

(54) PLUNGER LUBRICATOR HOUSING

(75) Inventors: Chadwick Dean Commins, Red Deer (CA); Ryan Spencer Smith, Sylvan Lake (CA)

Correspondence Address: DAVIS & BUJOLD, P.L.L.C., 112 PLEASANT STREET, CONCORD, NH, 03301, US

(73) Assignee: PENTAGON OPTIMIZATION SERVICES, Red Deer (CA)

(21) Appl. No.: 12/138,664

(22) Filed: Jun. 13, 2008

(51) Int. Cl. F16N 7/00; B23P 15/00

(52) U.S. Cl. 184/14; 29/592

(57) ABSTRACT

A plunger lubricator housing includes an elongated tubular body formed from a single piece of material. The body has a first end, a second end, an outer surface and an inner surface that defines a plunger receiving interior bore. Radial ports provide fluid communication between the interior bore and the outer surface. Each of the radial ports has a coupling that is recessed into the body.

### FIELD

This patent document relates to an integral housing for a plunger lubricator.

### BACKGROUND

When pressure within a wellbore is insufficient to cause production fluid to rise naturally, plunger lift systems are used in which a plunger provides a mechanical interface between lifted gas from the formation disposed below the plunger and produced fluid disposed above the plunger. A plunger lubricator is positioned at surface. The plunger lubricator has fluid flow outlet ports through which produced fluids may exist. It generally has a shock absorbing element to absorb the kinetic energy of the plunger. It also has a catcher assembly for use in recovering the plunger from the wellbore. Referring to FIG. 4, labelled as PRIOR ART, plunger lubricators that are currently used are formed by providing a cylindrical body 102, and welding external couplings to facilitate connection to the various fluid flow outlet ports 104 and other flow connections 106 of body 102. Plunger lubricators are designed to receive a plunger in the interior bore, and allow access to it such as by removing the stem 108 positioned on the top.

### SUMMARY

There is provided a plunger lubricator housing which includes an elongated tubular body formed from a single piece of material. The body has a first end, a second end, an outer surface and an inner surface that defines a plunger receiving interior bore. Radial ports provide fluid communication between the interior bore and the outer surface. Each of the radial ports has a coupling that is recessed into the body.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a perspective view of a plunger lubricator housing.

FIG. 2 is a side elevation view of the plunger lubricator housing of FIG. 1.

FIG. 3 is a perspective view of the plunger lubricator housing of FIG. 1, attached to a stem.

FIG. 4 is a perspective view of a prior art plunger lubricator attached to a different type of stem.

### DETAILED DESCRIPTION

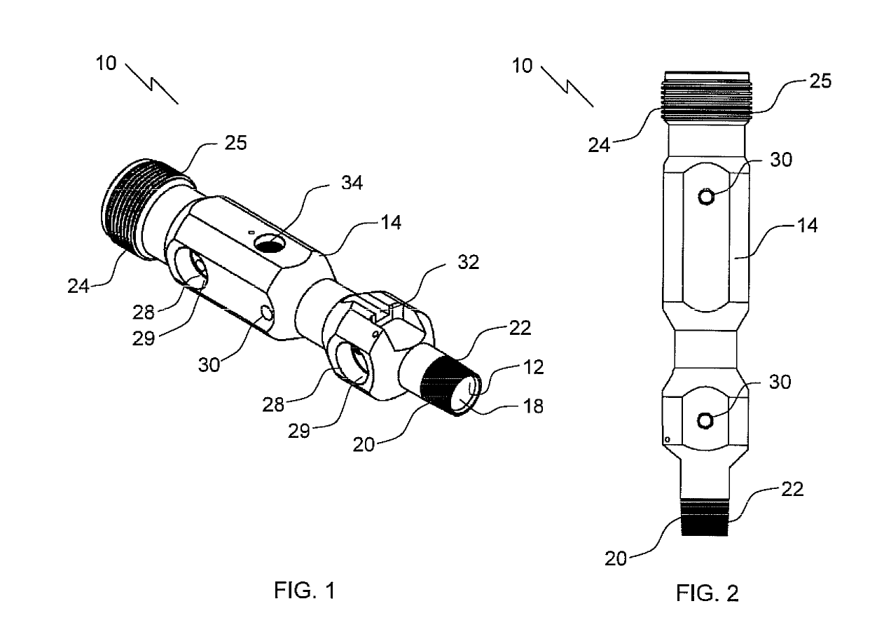

A plunger lubricator housing generally identified by reference numeral 10, will now be described with reference to FIG. 1 through 3.

### Structure and Relationship of Parts:

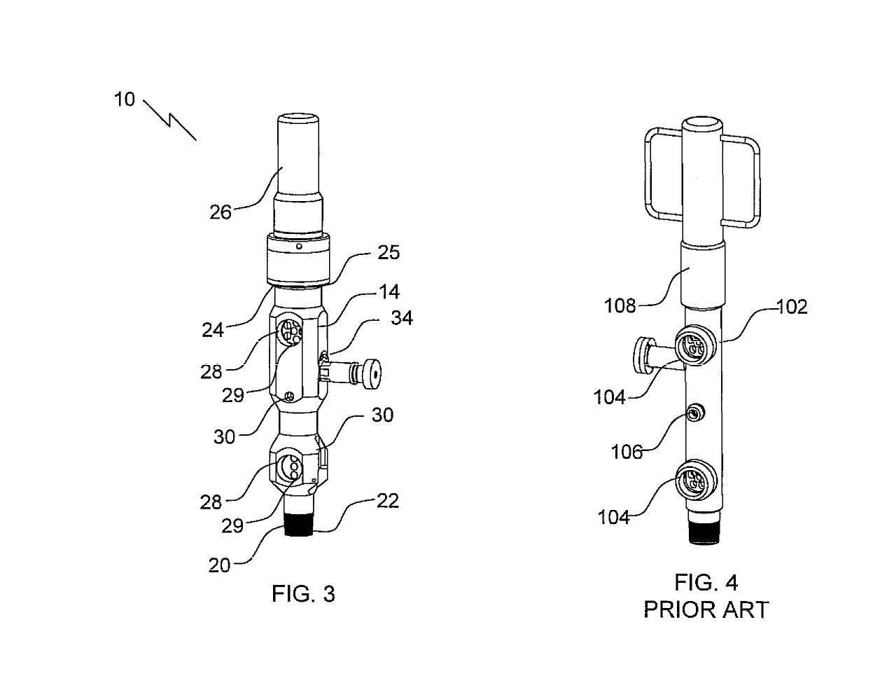

Referring to FIG. 1, body 10 has an inner surface 12 and an outer surface 14. Inner surface 12 defines a bore 18 for receiving a plunger. Referring to FIG. 3, body 10 also has a well head connection 20 at a first end 22 for connecting to a well head (not shown), and a step connection 24 at a second end 25 for connecting to a stem 26. In a preferred embodiment, body 10 is formed from machining bar stock, however it may also be formed using other known methods, such as forging, casting, etc.

Body 10 is provided with flow ports 28 for connecting to flow lines. Radial flow ports 28 are machined into body 10, and have threaded couplings 29 that are inset from outer surface 14. Referring to FIGS. 1 and 2, body 10 may also be provided with other ports 30, which may be used to attach gauges or sensors, or to inject chemicals. Referring to FIG. 1, body 10 may also include an equipment attachment 32 for attaching, for example, a magnetic sensor to indicate the arrival of a plunger, or a catch port 34 for catching a plunger at the top of its stroke. It will be understood that other components, such as lifting eyelets (not shown), may be welded or otherwise attached to body 10.

The body is constructed from a single piece of material as follows. First, a single piece of material is provided. The material is then machined, forged, or casted to form inner surface 12 (if necessary) and outer surface 14, where inner surface 12 defines a bore 18 for receiving a plunger. Well head connection 20 is machined at first end 22, and stem connection 24 is machined at second end 25 for connecting to a stem 26. Outer surface 14 is then machined to form ports 28, 30, and 34, equipment attachment 32. Outer surface 14 may be machined to have an increased thickness at various points along the length of body 10, such as an increased thickness about ports 28, 30 and 34 and about equipment attachment 32.

### Advantages:

It will be noted that, by comparison to the prior art lubricator shown in FIG. 4, body 10 is thicker around the various connections. This strengthens what are usually the weakest points of a plunger lubricator, namely, the connectors and the welds. Furthermore, as body 10 is machined from a single piece, any weaknesses from the required welds in the prior art are avoided. This reduces the risk of failure and the accompanying costs, including environmental costs. Other advantages from forming body 10 from a single piece relative to the traditional welded design include: reduced crevice corrosion, reduced long term maintenance costs, increased quality control during production, minimized QA/QC (quality assurance and quality control) requirements, and the metallurgy is consistent throughout body 10. In addition, since the body is machined, it relatively simple to customize the design of the ports and the housing to meet the needs of the end user.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A plunger lubricator housing, comprising:
an elongated tubular body formed from a single piece of material, the body having a first end, a second end, an outer surface, an inner surface that defines a plunger receiving interior bore, and radial ports providing fluid communication between the interior bore and the outer surface, each of the radial ports having a coupling that is recessed into the body.

2. The plunger lubricator housing of claim 1, wherein the body is thicker about the radial ports.

3. A method of constructing a plunger lubricator housing, comprising:
providing an elongated tubular body formed from a single piece of material having an outer surface and an inner surface that defines a plunger receiving bore;
machining a well head connection at a first end for connecting to a well head; and
machining radial flow ports that extend from the outer surface to the inner surface;
machining a recessed coupling for each of the radial ports to facilitate connection of each of the radial ports to flow lines.

4. The method of claim 3, further comprising the step of machining the outer surface such that the body is thicker about the radial ports.
